(19) United States
(12) Patent Application Publication
(10) Pub. No.: US 2024/0094352 A1
(43) Pub. Date: Mar. 21, 2024

(54) LIDAR DEVICE

(71) Applicant: Robert Bosch GmbH, Stuttgart (DE)

(72) Inventors: Holger Maris Gilbergs, Sersheim (DE); Johannes Richter, Renningen (DE)

(21) Appl. No.: 18/264,411

(22) PCT Filed: Feb. 4, 2022
(86) PCT No.: PCT/EP2022/052651

§ 371 Date: Aug. 4, 2023

(30) Foreign Application Priority Data
Feb. 10, 2021 (DE) 10 2021 201 247.7

(51) Int. Cl. G01S 7/481

(52) U.S. Cl. CPC G01S 7/4817; G01S 7/4815

(57) ABSTRACT

A lidar device having a light source, a detector, and a mirror device. The light source has a main radiation direction and the detector has a main detection direction. The mirror device is rotatable about an axis and has a facet wheel with a number of facets. The main radiation direction and the main detection direction stand at a predetermined angle to each other, the predetermined angle being a function of the number of facets. A light beam emitted from the light source is reflected by a first facet and a light beam reflected back from an object is reflected by a second facet. Here the first facet and the second facet are different.

### FIELD

The present invention relates to a lidar device and to a vehicle having such a lidar device.

### BACKGROUND INFORMATION

Lidar devices based on a rotating mirror are described in the related art. These have a light source and a detector, light being emitted by the light source via the rotatable mirror device, and a rotation of the mirror device causing a beam deflection. In this way, a radiation region can be scanned. Light reflected back from an object is then reflected again by the mirror device and impinges on the detector. A time-of-flight measurement, i.e. the measurement of a time it takes for a light beam to reach an object via the mirror device after leaving the light source, to be reflected back by the object, and to impinge on the detector again via the mirror device, enables a statement to be made as to how far away the object is from the lidar device. It is also conventional to design the mirror device as a so-called facet wheel, the facet wheel having a number of facets. As a rule, the facet wheel is designed in such a way that a regular n-gon is displaced perpendicularly to a plane defined by the n-gon, thereby forming a polygon, with lateral surfaces of the polygon representing the facets of the facet wheel. An axis perpendicular to the regular n-gon acts as the axis of rotation about which the facet wheel can be rotated. Light emitted from the light source strikes a facet of the facet wheel, and from there the object; light reflected back from the object strikes the same facet of the facet wheel and from there the detector. The light source and the detector are usually situated one above the other, i.e., in different planes relative to the axis of the facet wheel.

By rotating the facet wheel about the axis, a deflection of the light beam emitted by the light source in a plane perpendicular to the axis can take place. If in addition a deflection parallel to the axis is to take place, the light source can, for example, be additionally equipped with a beam deflection device, such as a tilting mirror or other device that allows the emitted light to be deflected parallel to the axis. In particular, the light source can be a laser.

Due to the fact that the light source and detector are configured one above the other, such lidar devices have a certain overall constructive height, so that an installation of such a lidar device in a vehicle is not possible at all desirable positions.

### SUMMARY

It is an object of the present invention to provide a lidar device in which a constructive height can be reduced. A further object of the present invention is to provide a vehicle having such a lidar device.

This object may be achieved by features of the present invention. Advantageous further developments are disclosed herein.

According to an example embodiment of the present invention, a lidar device has a light source, a detector, and a mirror device. The light source has a main radiation direction and the detector has a main detection direction. The mirror device is rotatable about an axis and has a facet wheel with a number of facets. The main radiation direction and the main detection direction are at a predetermined angle to each other, the predetermined angle being a function of the number of facets. A light beam emitted from the light source is reflected by a first facet of the facet wheel, while a light beam reflected back from an object is reflected by a second facet of the facet wheel. Here the first facet and the second facet are different. In particular, this means that the main radiation direction extends from the light source to the first facet and the main detection direction leads from the second facet to the detector. Due to the fact that different facets are used for the reflection of the emitted light beam and the re-incident light beam, the light source, detector and facet wheel can be configured within the lidar device in such a way that a constructive height of the lidar device can be reduced. To achieve this, the angle between the main radiation direction and the main detection direction has to be selected on the basis of the number of facets. The lidar device can include the further elements named in the existing art, such as the deflecting device for the light beam parallel to the axis. In addition, the light source can include a laser.

The facet wheel can also include a polygon in which a regular n-gon is displaced parallel to the axis, and the lateral surfaces of the polygon form the facets of the facet wheel.

In a specific example embodiment of the lidar device of the present invention, the light source and the detector are located on different sides of the mirror device (i.e., of the facet wheel). In particular, this enables a small constructive height of the lidar device for use in a vehicle, for example in a motor vehicle. Another advantage of this configuration can be that scattered light, which can reach the detector from the light source, can be suppressed and thus a more accurate measurement is possible.

In a specific embodiment of the present invention, the predetermined angle may be calculated using the formula 720° divided by the number of facets times a natural number plus/minus one tolerance deviation. The number of facets here corresponds to the number of corners of the regular n-gon of the polygon that defines the facet wheel. The natural number can be used to take into account whether and how many other facets, if any, are situated between the first facet and the second facet. If the natural number is selected equal to 1, the first facet and the second facet are directly adjacent to each other. If the natural number is equal to 2, then a further facet is situated between the first facet and the second facet. In a preferred specific embodiment, the natural number can be selected from the set {1; 2; 3}. Using the given formula, the angular relationship between the main radiation direction and the main detection direction can be easily determined as a function of the number of facets. If this angular relationship is selected, the result is that an emitted light beam reflected by the first facet is emitted in one radiation direction and a light beam incident opposite to the radiation direction is deflected to the detector via the second facet. The tolerance deviation can here be in particular 0. Thus, as an example, for a facet wheel with four facets the angle is 180°, and the natural number is chosen to be equal to 1 in this case; if the number of facets is five, the angle is 144° or 288°, in which case the natural number is chosen to be equal to 1 or 2; for six facets, the angle is 120° or 240°, in which case the natural number is chosen to be equal to 1 or 2; and in the case of eight facets, the angle is 90° or 180°, in which case the natural number is also chosen to be equal to 1 or 2. If the number of facets is ten, the angle selected can be 72°, 144° or 216°, and in this case the natural number is 1, 2, or 3.

If the stated angular relationship is used, it may be provided that a plane perpendicular to the axis is defined by the main radiation direction and the main detection direction, and the light source and the detector are situated in this plane. In particular, this enables a very low constructive height of the lidar device.

In a specific embodiment of the present invention, the main radiation direction and the main detection direction are each described by a three-dimensional vector with three components. A Cartesian coordinate system describing the vectors has an x axis, a y axis, and a z axis, the z axis being parallel to the axis (i.e. to the axis of rotation of the facet wheel). The vector of the main radiation direction has an x component, a y component and a z component, the y component of the vector being the main radiation direction 0. The vector of the main detection direction also has an x component, a y component and a z component, the x component and the y component of the vector of the main detection direction being a function of the x component of the vector of the main radiation direction and the z component of the vector of the main detection direction corresponding to the negative of the z component of the vector of the main radiation direction. It can be provided here that a two-dimensional projection of the main radiation direction and the main detection direction into the xy-plane is such that projection vectors with only the x component and the y component of the main radiation direction and the main detection direction correspond to the already-indicated angular relationship of 720° divided by the number of facets times a natural number plus/minus one tolerance deviation. This also enables more complicated geometries of the light source, detector, and facet wheel, which in turn permit a compact design of the lidar device.

In a specific embodiment of the present invention, a main plane is perpendicular to the axis, the main radiation direction and the main detection direction each deviating from the main plane by a maximum of 5°, and in particular each being situated in the main plane. This in turn enables a compact design of the lidar device, such that, in particular in the case in which the main radiation direction and the main detection direction do not lie in the main plane, if warranted advantageous geometries can be achieved, if the facet wheel is not to be configured perpendicular to a substrate, for example with respect to an installation position in a vehicle and the vehicle substrate.

In a specific embodiment of the present invention, the lidar device has a further light source, a further detector, and a further mirror device. The further mirror device is also rotatable about the axis and has a further facet wheel with a further number of facets, the further facet wheel being rigidly connected to the facet wheel and the further number of facets being different from the further number of facets. Due to the fact that the facet wheel and the further facet wheel are rigidly connected to each other, but the number of facets differs, a lidar device can be achieved in which advantageous illumination of a near range and a far range is possible. For example, if the number of facets is larger than the further number of facets, the rigid use of the facet wheel and the further facet wheel causes the light beam emitted by the further light source to move in a radiation area faster than the light beam emitted from the light source. The further light beam can then be used for a near range, closer to the lidar device, than the light beam, which is more suitable for a far range. This is particularly advantageous if the lidar device is to be used in a vehicle and, for example, a larger angle is to be covered in a near range than in a far range. Here the near range corresponds more to the immediate surrounding environment of the vehicle, and the far range corresponds more to a more distant road situation. Due to the otherwise indicated advantageous geometry of light source, facet wheel, detector, further light source, further facet wheel, and further detector, a lidar device can in this way be achieved which corresponds in its constructive height to more conventional lidar devices, but which has a significantly improved measuring range. In a specific embodiment, the further light source has a further main radiation direction parallel to the main radiation direction and the further detector has a further main detection direction parallel to the main detection direction. If this is the case, the light source and the further light source can be situated on one side of the mirror device, and the detector and the further detector can be situated on another side of the mirror device. In principle, an exemplary embodiment is also possible in which the further main radiation direction is antiparallel to the main detection direction and the further main detection direction is antiparallel to the main radiation direction. This is advantageous in particular if the light source or the further light source are significantly different in their constructive height from the detector or the further detector, and thus the light source and the further detector can be situated on one side of the mirror device and the detector and the further light source can be situated on another side of the mirror device, since the constructive height can be reduced in this way.

In a specific embodiment of the present invention, the number of facets is a multiple of the further number of facets. In particular, the number of facets is twice the further number of facets. For example, the further number of facets can be four and the number of facets can be eight. This makes it possible, in particular, to select an angle of 180° for both facet wheels in accordance with the above formula, thereby achieving a particularly compact configuration of the lidar device.

Of course, all specific embodiments of the present invention with further light source, further detector and further mirror device can also be configured, analogously to the realization described above, outside a main plane.

In a specific embodiment of the present invention, the detector is set up to filter incident light according to a property of the light source and the further detector is set up to filter incident light according to a property of the further light source. In particular, it can be provided that the light source and the further light source each have a different light wavelength, and the detector and the further detector have a corresponding wavelength filter. Alternatively, it can be provided that the light emitted from the light source and the further light source is modulated with different frequencies and the signal from the detector and the further detector is filtered according to these different modulation frequencies.

The present invention further includes a vehicle, in particular a motor vehicle, having the lidar device according to the present invention. The lidar device can be situated directly under the roof, in the radiator grille, or behind a windshield of the vehicle.

Exemplary embodiments of the present invention are explained with reference to the figures.

### BRIEF DESCRIPTION OF THE DRAWINGS

FIG. 1 shows a lidar device, according to an example embodiment of the present invention.

FIG. 2 shows a further lidar device, according to an example embodiment of the present invention.

FIG. 3 shows a frontal plan view of the further lidar device.

FIG. 4 shows an isometric view of a further lidar device.

FIG. 5 shows the beam deflection design of the lidar device, according to an example embodiment of the present invention.

FIG. 6 shows a further lidar device, according to an example embodiment of the present invention.

FIG. 7 shows a frontal view of the further lidar device.

FIG. 8 shows a frontal view of a further lidar device.

FIG. 9 shows a vehicle, according to an example embodiment of the present invention.

### DETAILED DESCRIPTION OF EXAMPLE EMBODIMENTS

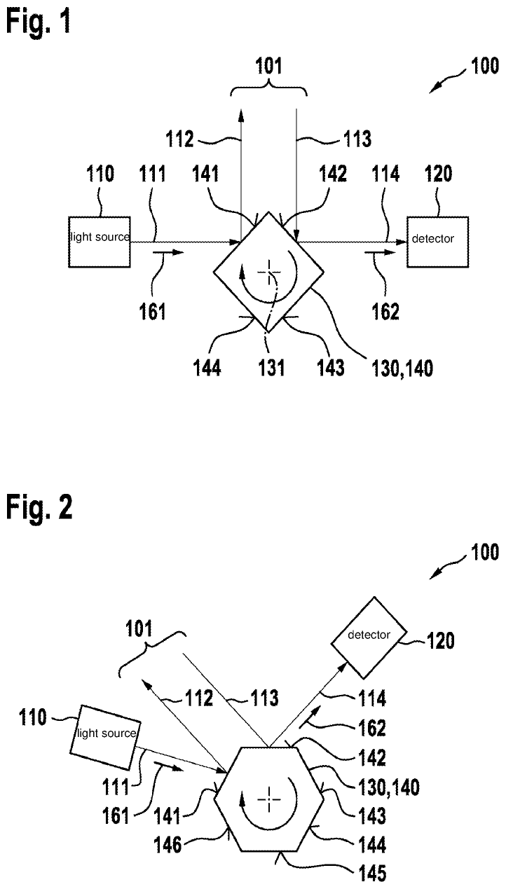

FIG. 1 shows a lidar device 100 with a light source 110, a detector 120, and a mirror device 130. Mirror device 130 can be rotated about an axis 131. Mirror device 130 further includes a facet wheel 140 having a number of facets. Facet wheel 140 includes a first facet 141, a second facet 142, a third facet 143, and a fourth facet 144. The number of facets is therefore four. A light beam 111 emanating from light source 110 impinges on mirror device 130, i.e., on facet wheel 140, and is reflected at first facet 141. The reflected outgoing light beam 112 is radiated in the direction of a radiation area 101. If an object (not shown) is located in radiation area 101, a reflected light beam 113 is reflected from the object back to lidar device 100. The reflected light beam 113 is reflected at second facet 142 and impinges on detector 120 as mirror-reflected light beam 114. The direction of the emitted light beam 111 here corresponds to a main radiation direction 161, and a main detection direction 162 corresponds to the direction of mirror-reflected light beam 114. Here, main radiation direction 161 represents a main direction of radiation of light from light source 110, while main detection direction 162 defines a direction in which light can be incident on detector 120. Thus, the light beam 111 emitted from the light source is reflected by first facet 141 and a light beam 113 reflected by an object is reflected by second facet 142. Main radiation direction 161 and main detection direction 162 are at a predetermined angle to each other, which in FIG. 1 is 180°. This angle is a function of the number of facets of facet wheel 140, i.e. if the facet wheel 140 has a number of facets other than four, the specified angle may be other than 180°.

Facet wheel 140 is square in FIG. 1, meaning that a polygon defining the respective facets 141, 142, 143, 144 is a square, this square being displaceable along axis 131 and thus forming a polygon with facets 141, 142, 143, 144.

FIG. 2 shows another embodiment of a lidar device 100 that corresponds to lidar device 100 of FIG. 1, except for any differences described below. In this embodiment, facet wheel 140 of mirror device 130 has six facets, i.e. in addition to first facet 141, second facet 142, third facet 143, and fourth facet 144, it has a fifth facet 145 and a sixth facet 146. In this case, facet wheel 140 is formed by a regular hexagon, which is displaced parallel to axis 131, thus forming the six facets 141, 142, 143, 144, 145, 146.

Outgoing light beam 111 impinges on first facet 141 and is reflected by it, and exits lidar device 100 as a reflected outgoing light beam 112 in the direction of radiation area 101. A reflected light beam 113 is reflected from second facet 142 in the direction of detector 120 and impinges on detector 120 as a mirror-reflected light beam 114. In this embodiment, main radiation direction 161 and main detection direction 162 are at an angle of 120° to each other. This is because the higher number of facets of facet wheel 140 means that an angle between first facet 141 and second facet 142 is greater than in facet wheel 140 of FIG. 1, thus changing the overall angular relationships.

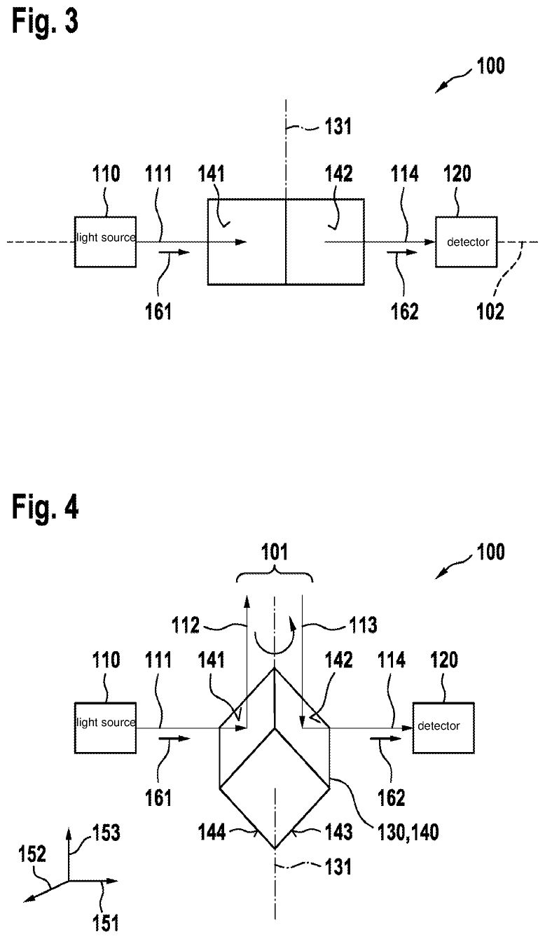

FIG. 3 shows a front view of lidar device 100 of FIG. 2. FIG. 3 is drawn such that the viewer is looking at lidar device 100 from radiation area 101 and light beam 112 reflected by first facet 141 runs towards the viewer, and light beam 113 reflected by the object runs away from the viewer towards second facet 142, is reflected there, and runs as a mirror-reflected light beam 114 in the direction of detector 120.

In the embodiments of FIGS. 1 to 3, it can be provided that light source 110 and detector 120 are respectively situated on different sides of mirror device 130, as also shown for example in FIGS. 1 to 3. Further, the angle between main radiation direction 161 and main detection direction 162 can be calculated quite generally using the formula 720° divided by the number of facets times a natural number plus/minus one tolerance deviation. The natural number here corresponds to the number of facets, increased by 1, between the first facet 141 and the second facet 142. Therefore, in the embodiments of FIGS. 1 to 3, the natural number is 1, and the result for the embodiment of FIG. 1 is 720° divided by 4 for the number of facets, i.e. 180°, while for the embodiment of FIG. 2 the result is 720° divided by 6 for the number of facets, i.e. 120°. In particular in the case of facet wheels with more than four facets, it can be provided that the first facet 141 and the second facet 142 are not directly adjacent to each other, in which case the angle between main radiation direction 161 and main detection direction 162 correspondingly still has to be multiplied by a natural number, the natural number being equal to the number of facets between the first facet 141 and the second facet 142, plus 1.

It can be provided that main radiation direction 161 and main detection direction 162 are collinear, as shown for example in the embodiment of FIG. 1. Main radiation direction 161 and main detection direction 162 can also be collinear if the facet wheel has a number of facets that is a multiple of four, for example eight or twelve facets, and the light beam 113 reflected from the object strikes the next facet but one in the case of the facet wheel with eight facets, and strikes the next facet but two in the case of a facet wheel with twelve facets.

In the embodiment of FIG. 3, it can also be seen that light source 110, the facet wheel or mirror device 130, and detector 120 are situated in a main plane 102. It can further be provided that a small tolerance deviation of up to 5° is provided by which main radiation direction 161 and main detection direction 162 deviate from main plane 102.

FIG. 4 shows a view of another exemplary embodiment of a lidar device 100 corresponding to lidar device 100 of FIG. 1, except for any differences described below. In this embodiment, main radiation direction 161 and main detection direction 162 are each described by a three-dimensional vector having three components, where a Cartesian coordinate system for the description of the vectors has an x axis 151, a y axis 153, and a z axis 153, the z axis 153 being parallel to the first axis 131. The vector of main radiation direction 161 has an x component, a y component and a z component, the y component being 0. Main detection direction 162 also has an x component, a y component, and a z component, the z component of main detection direction 162 corresponding to the negative of the z component of main radiation direction 161, and the x component and the y component of main detection direction 162 being calculable from main radiation direction 161. In the case shown here, with a facet wheel 140 with four facets, this consideration simplifies to: main detection direction 162 also has only an x component and the y component is 0, which results from the angular relationship of 180° already described. However, if facet wheel 140 has a number of facets different from 4, as shown for example in FIG. 2, a two-dimensional projection in the xy-plane of main radiation direction 161 and main detection direction 162 then again corresponds to the angular relationship of 120° already described, while the z components of main radiation direction 161 and main detection direction 162 are each negative to one another.

This embodiment thus corresponds in principle to an inclined facet wheel 140; here the z components must be taken into account due to the inclined position, and for the x component and y component an identical relationship to the angular relationship already described can be observed for the facet wheel 140.

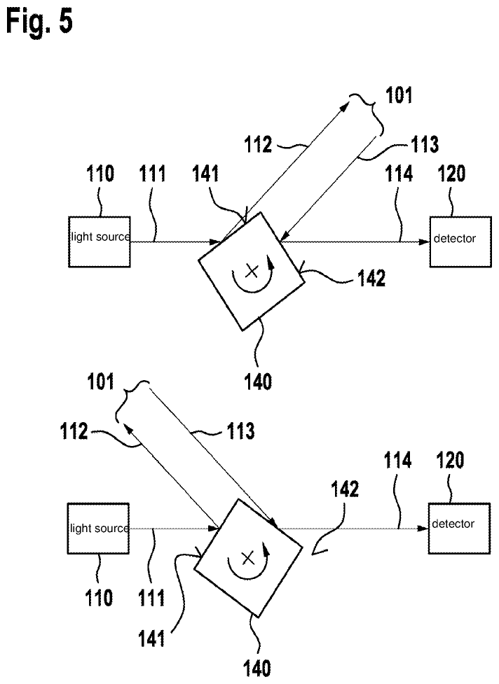

FIG. 5 shows, in two illustrations, different positions of facet wheel 140 of FIG. 1 at different angles of rotation, thus showing that radiation area 101 is located in different directions depending on the position of the facet wheel 140, the angular relationships between outgoing light beam 111, outgoing light beam 112 reflected by the first facet 141, light beam 113 reflected from the object, and mirror-reflected light beam 114 being in each case such that the angular relationship between main radiation direction 161 and main detection direction 162 is maintained.

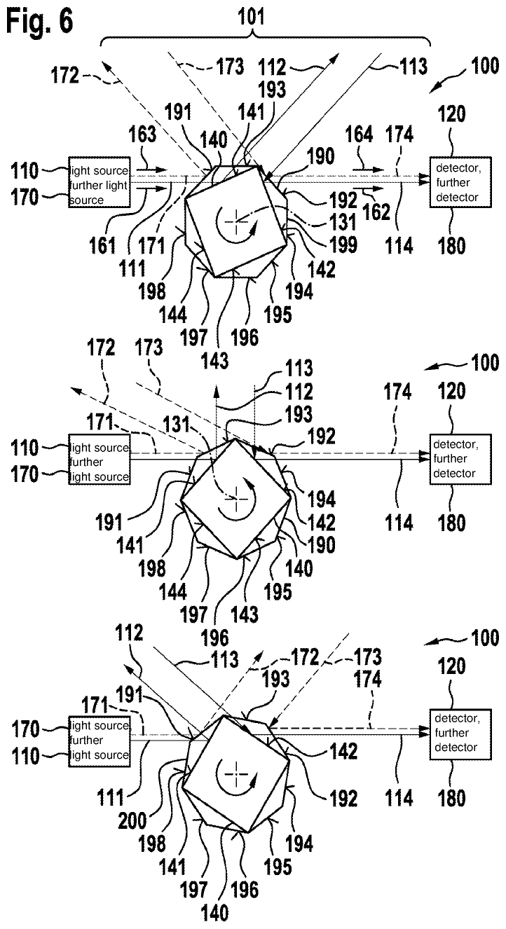

FIG. 6 shows a plan view of a further lidar device 100, which basically includes light source 110, detector 120 and mirror device 130 with facet wheel 140, as described in connection with FIG. 1. Lidar device 100 has in addition a further light source 170, a further detector 180, and a further mirror device 190, further mirror device 190 having a further facet wheel 199 that has a first facet 191, a second facet 192, a third facet 193, a fourth facet 194, a fifth facet 195, a sixth facet 196, a seventh facet 197, and an eighth facet 198. The two facet wheels 140, 199 are rigidly connected to each other and can be rotated about axis 131. When counting the facets of further facet wheel 199, it should be noted that third facet 193 is situated between first facet 191 and second facet 192. A further light beam 171 going out from further light source 170 strikes first facet 191 of further facet wheel 199 and is reflected from there to form the further reflected outgoing light beam 172. A further reflected light beam 173 reflected from an object is reflected at second facet 192 of further facet wheel 199 to further detector 180. Due to the fact that third facet 193 of further facet wheel 199 is situated between first facet 191 and second facet 192, an angular relationship identical to light source 110 and detector 120, which also results from the formula described above, also holds for further light source 170 and further detector 180. With such a lidar device, it is possible to achieve a faster, in angular terms, scan of radiation area 101 with further facet wheel 199, while a slower scan is possible with facet wheel 140. This is made clear by the two further illustrations in FIG. 6, in which mirror device 130, 190 each continued to rotate, although in the bottom illustration it should be noted that further light beam 171 emitted by further light source 170 is now already impinging on the next facet, which now becomes the first facet. The original first facet 200 is now the eighth facet 198 of further facet wheel 199.

From FIG. 6, it can be seen that the light beam deflected by facet wheel 140 scans a larger scanning area four times per full revolution, while further facet wheel 199 scans a smaller scanning area eight times. Thus, for example, it can be provided that lidar device 100 of FIG. 6 can be used to measure a near range using light source 110, facet wheel 140 and detector 120, while the further light source, further facet wheel 199 and further detector 180 are used to measure a far range.

In particular, this works when the number of facets of facet wheel 140 is different from another number of facets of further facet wheel 199. In particular, it can be provided that a further main radiation direction 163 is parallel to the main radiation direction or antiparallel to the main radiation direction 161, and a further main detection direction 164 is parallel or antiparallel to the main detection direction 162. This enables a compact design of a lidar device 100 with two different distance measurement ranges.

FIG. 6 shows that all facets 141, 142, 143, 144 of facet wheel 140 are each not parallel to the further facets 191, 192, 193, 194, 195, 196, 197, 198 of further facet wheel 199. In other words, this means that the two facet wheels 140, 199 are configured at an angle to each other such that no facet 141, 142, 143, 144 of facet wheel 1401 forms a common plane with another facet 191, 192, 193, 194, 195, 196, 197, 198 of further facet wheel 199. In this way, it can be achieved that the reflected outgoing light beam 112 and the further reflected outgoing light beam 172 are emitted in a different spatial direction at each point in time, and thus back-scattered light of different spatial directions is detected, thereby minimizing a mutual influencing of detector 120 by further light source 170 and of further detector 180 by light source 110. There is then, therefore, a phase difference between the two scans. Alternatively, it can also be provided that some of the facets 141, 142, 143, 144 of facet wheel 140 are each parallel to further facets 191, 192, 193, 194, 195, 196, 197, 198 of further facet wheel 199. In this case, it can be provided that influencing by filters, as explained below, is minimized.

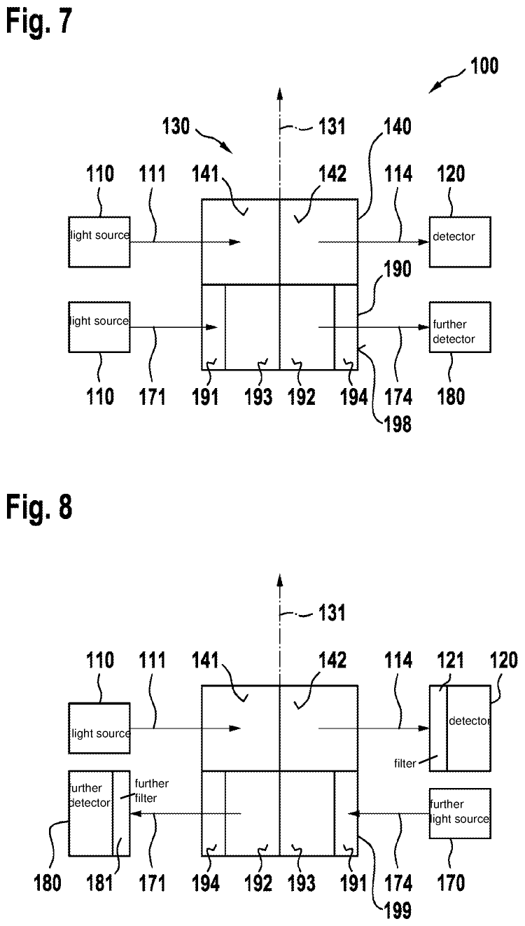

FIG. 7 shows a frontal view of lidar device 100 of FIG. 6, i.e. shows the lidar device 106 as seen from radiation area 101. Here light source 110 and further light source 170 as well as detector 120 are each situated on one side of mirror device 130 and further mirror device 190, respectively, and detector 120 and further detector 180 are each situated on the other side of mirror device 130 or 190, respectively. Light source 110 and further light source 170 are thus configured one above the other, as are detector 120 and further detector 180.

FIG. 8 shows a lidar device 100 which also has a further light source 170, a further detector 180 and a further mirror device 190 analogous to FIGS. 6 and 7, although in this case light source 110 and further detector 180 and further light source 170 and detector 120 are each situated one above the other, with light source 110, facet wheel 140 and detector 120 and further light source 170, further facet wheel 199 and further detector 180 each being situated in a plane. This allows for a more compact design in particular if, as shown in FIG. 8, detectors 120, 180 are significantly higher than light sources 110, 170 the same is true for the other possible case, namely that light sources 110, 170 are higher than detectors 120, 180.

In the embodiment of lidar device 100 described in connection with FIGS. 6 to 8, it can in particular be provided that the further number of facets of further facet wheel 199 is a multiple of the number of facets of facet wheel 140. In particular, this makes it possible to design the main radiation direction 161 and the further main radiation direction 163 parallel or antiparallel to each other, and to design the main detection direction 162 and the further main detection direction 164 parallel or antiparallel to each other.

The exemplary embodiment explained in connection with FIGS. 6 to 8 can also be designed for a facet wheel 140 or further facet wheel 198 configured with an incline, analogous to FIG. 4.

FIG. 8 also shows that detector 120 includes an optional filter 121 and further detector 180 includes an optional further filter 181. In particular, it can be provided here that the light emitted by light source 110 has a different wavelength than the light emitted by further light source 170, and filter 121 is set up to filter the wavelength of light source 110, and further filter 181 is set up to filter the wavelength of the light emitted by further light source 170. The optional filters 121, 181 can also be provided in the exemplary embodiment of FIG. 7. In addition to being designed as color filters, optional filters 121, 181 can also be set up, for example, to filter the light emitted by light sources 110, 170 with regard to an amplitude modulation, the light emitted by light source 110 being modulated with a different frequency than the light emitted by further light source 170.

In particular, light source 110 and also further light source 170 can include a laser. It can further be provided that light source 110 and further light source 170 each have a deflection device, not shown, with which the emitted light can be controllably deflected parallel to axis 131 to enable lidar device 110 to perform measurements not only in one plane, but also to some extent parallel to axis 131 in different planes.

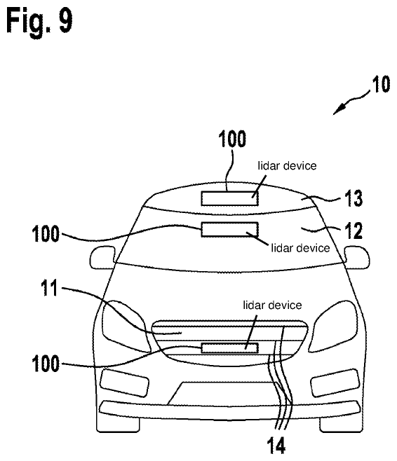

FIG. 9 shows a vehicle 10 with a radiator grille 11, a windshield 12, and a roof 13. The described structure of the lidar device 100 of FIGS. 1 to 8 enables a particularly compact structure of the lidar device 100, i.e. having a low constructive height in particular in the direction of axis 131. As a result, the lidar device 100 can be situated in the area of the radiator grille 11 between radiator grille louvers 14, or in the area of the windshield 12 or in the area of the roof 13.

Thus, lidar device 100 can be provided at least one of the mentioned spaces within vehicle 10.

Although the present invention has been illustrated and described in detail through the preferred exemplary embodiments, the present invention is not limited to the disclosed examples, and other variations may be derived therefrom by those skilled in the art without departing from the scope of protection of the present invention.

1-10. (canceled)

11. A lidar device, comprising:
a light source;
a detector; and
a mirror device, the light source having a main radiation direction and the detector having a main detection direction, the mirror device being rotatable about an axis, the mirror device having a facet wheel with a number of facets, the main radiation direction and the main detecting direction being at a predetermined angle to each other, the predetermined angle being a function of the number of facets, a light beam emitted from the light source being reflected by a first facet of the facets, a light beam reflected back from an object being reflected by a second facet of the facets, the first facet and the second facet being different from one another.

12. The lidar device as recited in claim 11, wherein the light source and the detector are situated on different sides of the mirror device.

13. The lidar device as recited in claim 11, wherein the predetermined angle is calculable using the formula 720 degrees divided by the number of facets times a natural number plus/minus one tolerance deviation.

14. The lidar device as recited in claim 11, wherein the main radiation direction and the main detection direction each being described by a three-dimensional vector having three components, a Cartesian coordinate system for describing the vectors having an x axis, a y axis, and a z axis, the z axis being parallel to the axis about which the mirror device is rotatable, the vector of the main radiation direction having an x component, a y component, and a z component, the y component of the vector of the main radiation direction being zero, the vector of the main detection direction having an x component, a y component, and a z component, the x component and the y component of the vector of the main detection direction being a function of the x component of the vector of the main radiation direction, and the z component of the vector of the main detection direction corresponding to a negative of the z component of the vector of the main radiation direction.

15. The lidar device as recited in claim 11, wherein a main plane standing perpendicular to the axis, and the main radiation direction and the main detection direction each deviating from the main plane by a maximum of 5 degrees.

16. The lidar device as recited in claim 11, further comprising:
a further light source;
a further detector; and
a further mirror device, the further mirror device being rotatable about the axis, the further mirror device having a further facet wheel that has a further number of further facets, the further facet wheel being rigidly connected to the facet wheel, and the facet number being different from the further facet number.

17. The lidar device as recited in claim 16, wherein the further light source has a further main detection direction parallel to the main detection direction, and the further detector having a further main detection direction parallel to the main detection direction.

18. The lidar device as recited in claim 16, wherein the facet number is a multiple of the further facet number.

19. The lidar device as recited in claim 16, wherein the detector is configured to filter incident light according to a property of the light source and the further detector is configured to filter incident light according to a property of the further light source.

20. A vehicle, comprising:
a lidar device, including:
a light source,
a detector, and
a mirror device, the light source having a main radiation direction and the detector having a main detection direction, the mirror device being rotatable about an axis, the mirror device having a facet wheel with a number of facets, the main radiation direction and the main detecting direction being at a predetermined angle to each other, the predetermined angle being a function of the number of facets, a light beam emitted from the light source being reflected by a first facet of the facets, a light beam reflected back from an object being reflected by a second facet of the facets, the first facet and the second facet being different from one another.
